(19) United States
(12) Patent Application Publication
(10) Pub. No.: US 2016/0204469 A1
(43) Pub. Date: Jul. 14, 2016

(54) LITHIUM ION BATTERY ELECTROLYTES AND ELECTROCHEMICAL CELLS

(71) Applicant: 3M INNOVATIVE PROPERTIES COMPANY, Saint Paul, MN (US)

(72) Inventors: John C. Burns, Nova Scotia (CA); Jeffrey R. Dahn, Nova Scotia (CA); Kevin W. Eberman, St. Paul, MN (US); Gaurav Jain, Edina, MN (US); William M. Lamanna, Stillwater, MN (US); Nupur Nikkan Sinha, Milpitas, CA (US); Ang Xiao, Woodbury, MN (US); Hui Ye, Maple Grove, MN (US)

(21) Appl. No.: 14/911,086

(22) PCT Filed: Aug. 6, 2014
(86) PCT No.: PCT/US14/49883

§ 371 Date: Feb. 9, 2016

Related U.S. Application Data
(60) Provisional application No. 61/868,043, filed on Aug. 20, 2013.

(51) Int. Cl. H01M 10/0567; H01M 10/0525; H01M 10/0568; H01M 10/0569

(52) U.S. Cl. CPC H01M 10/0567; H01M 10/0569; H01M 10/0525; H01M 10/0568; H01M 2300/0025

(57) ABSTRACT

An electrolyte solution for a lithium ion battery, the electrolyte solution includes water, a cyclic carbonate, and a lithium imide salt. In one embodiment of the present disclosure, an electrolyte solution for a lithium ion battery is provided, wherein the electrolyte solution includes: a lithium ion battery charge carrying medium; water; a cyclic carbonate; and a lithium imide salt; wherein the water is present in an amount of at least 100 parts per million (ppm) (or at least 200 ppm), based on the total weight of the electrolyte solution.

### BACKGROUND

While commercial lithium ion batteries (LIBs) perform satisfactorily for most home electronics applications, currently available LIB technology does not satisfy some of the more demanding performance goals for Hybrid Electric Vehicles (HEV), Plug-in Hybrid Electric Vehicles (PHEV), or Pure Electric Vehicles (EV). In particular, currently available LIB technology does not meet the 10-15 year calendar life requirement set by the Partnership for a New Generation of Vehicles (PNGV). The most extensively used LIB electrolytes are composed of LiPF₆ dissolved in organic carbonates or esters; however, these commonly used electrolytes have limited thermal and high voltage stability. Thermal and electrochemical degradation of the electrolyte is considered a primary cause of reduced Li ion battery performance over time. Many of the performance and safety issues associated with advanced lithium ion batteries are the direct or indirect result of undesired reactions that occur between the electrolyte and the highly reactive positive or negative electrodes. Such reactions result in reduced cycle life, capacity fade, gassing (which can result in cell venting), impedance growth and reduced rate capability. Typically, driving the electrodes to greater voltage extremes or exposing the cell to higher temperatures accelerates these undesired reactions and magnifies the associated problems. Under rare but extreme abuse conditions, uncontrolled reaction exotherms may occur that result in thermal runaway and catastrophic disintegration of the cell.

Stabilizing the electrode/electrolyte interface is important to controlling and minimizing these undesirable reactions and improving the cycle life and voltage and temperature performance limits of LIBs. Electrolyte additives designed to selectively react with, bond to, or self organize at, the electrode surface in a way that passivates the interface represents one of the simplest and potentially most cost effective ways of achieving this goal. The effect of common electrolyte solvents and additives, like ethylene carbonate (EC), vinylene carbonate (VC), fluorinated ethylene carbonate (FEC), and lithium bisoxalatoborate (LiBOB), on the stability of the negative electrode SEI (solid-electrolyte interface) layer is well documented. Evidence suggests that vinylene carbonate (VC) and lithium bisoxalatoborate (LiBOB), for example, react on the surface of the anode to generate a more stable Solid Electrolyte Interface (SEI). These electrolytes suffer from poor calendar life and fast capacity fade at elevated temperatures (e.g., >45° C.) and high voltage (e.g., >4.2Vvs. Li/Li⁺). Stabilizing the SEI and inhibiting the detrimental thermal and redox reactions that can cause electrolyte degradation at the electrode interface (both cathode and anode) will lead to extended calendar life and enhanced thermal stability of LIBs.

### SUMMARY

The present disclosure provides electrolyte solutions for lithium ion batteries that include water.

Contrary to conventional belief, maintaining a certain water content in electrolytes for lithium ion batteries can improve long-term performance while at the same time reduce costs of Li-ion cells. Although the present disclosure demonstrates that the tight water specifications of electrolytes can be relaxed, the present disclosure also demonstrates that maintaining a certain level of water can be beneficial to performance.

In one embodiment of the present disclosure, an electrolyte solution for a lithium ion battery is provided, wherein the electrolyte solution includes: a lithium ion battery charge carrying medium; water; a cyclic carbonate; and a lithium imide salt; wherein the water is present in an amount of at least 100 parts per million (ppm) (or at least 200 ppm), based on the total weight of the electrolyte solution.

In one embodiment, the present disclosure provides an electrolyte solution for a lithium ion battery, wherein the electrolyte solution includes: a lithium ion battery charge carrying medium; water; a cyclic carbonate that includes a carbon-carbon unsaturated bond or a cyclic carbonate of Formula (1):

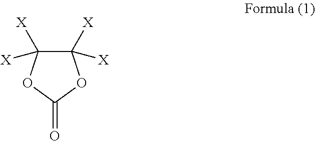

wherein each X is independently a hydrogen or a halogen, and at least one X is a halogen; and a lithium imide salt has the following Formula (2):

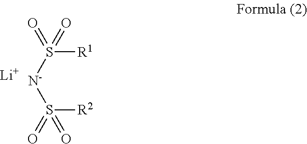

wherein: R¹ represents CₘX₂ₙ₊₁; R² represents CₙX₂ₙ₊₁; m and n are each independently an integer of 1 to 8; and each X is independently a hydrogen or halogen; wherein the water is present in an amount of at least 100 ppm, based on the total weight of the electrolyte solution.

In one embodiment, the present disclosure provides a lithium ion electrochemical cell that includes: a positive electrode (e.g., one that includes a lithium metal oxide); a negative electrode (e.g., one that includes carbon, silicon, lithium, titanate, or a combination thereof); and an electrolyte solution as described herein.

In certain embodiments, water is present in the electrolyte solutions of the present disclosure in an amount of less than 2000 ppm, or in some embodiments, less than 1000 ppm. The terms “comprises” and variations thereof do not have a limiting meaning where these terms appear in the description and claims.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.”

The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used.

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

When a group is present more than once in a formula described herein, each group is “independently” selected, whether specifically stated or not. For example, when more than one X group is present in a formula, each X group is independently selected.

As used herein, the term “room temperature” refers to a temperature of about 20° C. to about 25° C. or about 22° C. to about 25° C.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF DRAWINGS

FIG. 1 shows a schematic cross sectional view of an exemplary lithium ion battery (i.e., lithium ion electrochemical cell).

### DETAILED DESCRIPTION OF EXEMPLARY EMBODIMENTS

The present disclosure provides an electrolyte solution for a lithium ion battery. The electrolyte solution includes a cyclic carbonate and a lithium imide salt along with water. It has been discovered that water can be tolerated in such solutions, and in certain situations, water even provides advantage.

The addition of water to such electrolytes in lithium ion batteries results in improved cycle life, high voltage stability, high temperature resiliency, and/or reduced impedance buildup especially at low temperature. More specifically, the addition of water to such electrolytes in lithium ion batteries that include a cyclic carbonate and a lithium imide salt results in one or more of the following advantages: (1) small changes in voltage drop during storage; (2) improved capacity retention during long term cycling at both 40° C. and 55° C.; (3) lower charge transfer resistance compared to the same cell with no added water; (4) decreased rates of parasitic reactions compared to the same cell with no added water; and (5) acceptable cell performance under conditions where moisture levels in the electrolyte are elevated. The ability for water to be tolerated is important in reducing manufacturing costs. Reduction in manufacturing costs is important to the growth of Li ion batteries in electronics applications and to the success of this technology in the automotive sector.

A lithium ion electrochemical cell includes a positive electrode, a negative electrode, an electrolyte solution, and a charge carrying medium. In one aspect, the present disclosure provides a rechargeable electrochemical cell that includes a positive electrode having at least one electroactive material having a recharged potential, a negative electrode, a charge-carrying electrolyte comprising a charge carrying medium and an electrolyte salt, and water dissolved in an electrolyte.

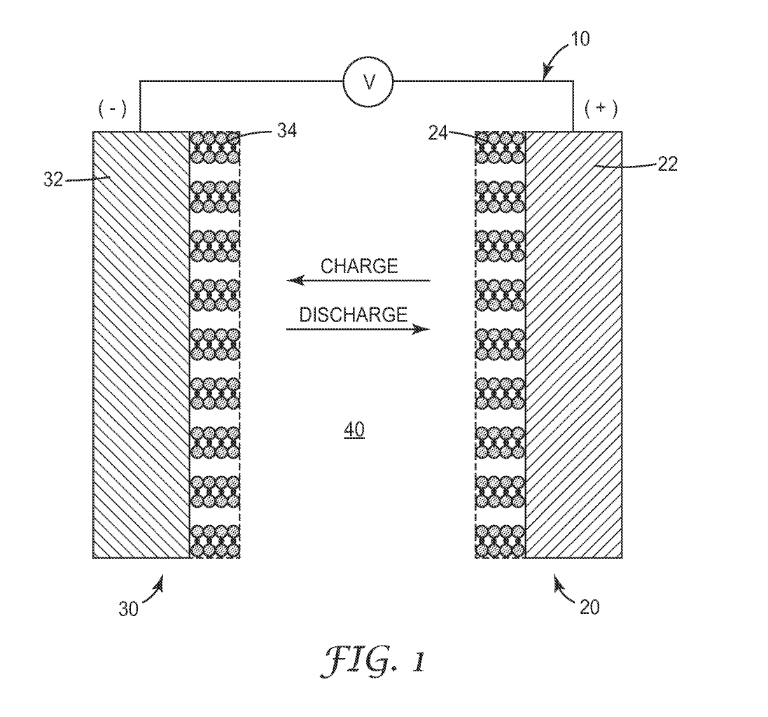

FIG. 1 shows an exemplary schematic cross sectional view of a lithium ion battery, in which 10 represents the external connections to the battery, 20 represents the positive electrode with an active material 24 coated onto a positive current collector 22, 30 represents the negative electrode with an active material 34 coated onto negative current collector 32, and 40 represents a separator and electrolyte. During charging and discharging of the battery, lithium ions move between the positive electrode 20 and the negative electrode 30. For example, when the battery is discharged, lithium ions flow from the negative electrode 30 to the positive electrode 20. In contrast, when the battery is charged, lithium ions flow from the positive electrode 20 to the negative electrode 30.

In one embodiment of the present disclosure, an electrolyte solution for a lithium ion battery is provided, wherein the electrolyte solution includes: a lithium ion battery charge carrying medium; and water; a cyclic carbonate; and a lithium imide salt; wherein the water is present in an amount of at least 100 parts per million (ppm), based on the total weight of the electrolyte solution.

In certain embodiments, water is present in the electrolyte solution in an amount of at least 200 ppm. In certain embodiments, water is present in the electrolyte solution in an amount of less than 2000 ppm. In certain embodiments, water is present in the electrolyte solution in an amount of less than 1000 ppm.

In certain embodiments, the cyclic carbonate is present in the electrolyte solution in an amount of at least 0.1 weight percent, or at least 0.5 weight percent, or at least 1 weight percent, or at least 2 weight percent, based on the total weight of the electrolyte solution. In certain embodiments, the cyclic carbonate is present in the electrolyte solution in an amount of up to 10 weight percent, or up to 5 weight percent, or up to 2 weight percent, based on the total weight of the electrolyte solution.

In certain embodiments, the cyclic carbonate includes a carbon-carbon unsaturated bond. In certain embodiments, the cyclic carbonate is selected from vinylene carbonate (VC), vinyl ethylene carbonate, and combinations thereof. In certain embodiments, such cyclic carbonates are preferred.

In certain embodiments, the cyclic carbonate has the following Formula (1):

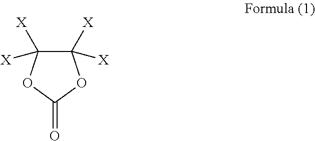

wherein each X is independently a hydrogen or a halogen, and at least one X is a halogen. In certain embodiments, the cyclic carbonate includes fluoro ethylene carbonate.

In certain embodiments, the lithium imide salt is present in the electrolyte solution in an amount of at least 0.1 weight percent, or at least 0.5 weight percent, or at least 1 weight percent, or at least 2 weight percent, based on the total weight of the electrolyte solution. In certain embodiments, the lithium imide salt is present in the electrolyte solution in an amount of up to 10 weight percent, or up to 5 weight percent, or up to 2 weight percent, based on the total weight of the electrolyte solution.

In certain embodiments, the lithium imide salt has the following Formula (2):

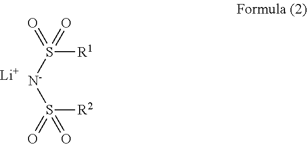

wherein: R¹ represents CₘX₂ₘ₊₁; R² represents CₙX₂ₙ₊₁; m and n are each independently an integer of 1 to 8; and each X is independently a hydrogen or halogen. In certain embodiments, the lithium imide salt includes LiN(SO₂CF₃)₂ (lithium bis(trifluoromethane)sulfoneimide available under the tradename HQ-115 from 3M Company).

In certain embodiments, the electrolyte solution includes a cyclic carbonate of Formula (1) and a lithium imide salt of Formula (2).

The present disclosure describes that the addition of water, particularly 200-2000 ppm water, to an electrolyte solution that includes a cyclic carbonate and a lithium imide salt of Formula (2), particularly vinylene carbonate and LiN(SO₂CF₃)₂, results in small changes in voltage drop during storage and long term cycling at both 40° C. and 55° C. Furthermore, the addition of 1000 ppm water is, surprisingly, beneficial compared to no added water. Benefits in adding 1000 ppm water to these electrolytes also generally include lower charge transfer resistance and decreased rates of parasitic reactions within the cell (measured through high precision coulometry cycling techniques). This shows that at these relatively low loading levels of water in the electrolyte there are no obvious detrimental effects to cell performance, in fact improvement in key performance characteristics may be obtained by maintaining a certain water level in the electrolyte. This will also allow reduction in cost of Li ion batteries by eliminating the need to have low water content in the electrolyte.

Significantly, as shown in the examples, the addition of 100 ppm or 1000 ppm water, for example, to electrolyte containing VC and HQ-115 lithium imide salt in LiCoO₂/graphite cells or LiNi_{0.42}Mn_{0.42}Co_{0.16}O₂/graphite cells gives good overall cell performance with high measured coulombic efficiencies, low voltage drop during storage, good capacity retention during long term cycling, low charge transfer resistance and only moderate swelling.

Interestingly, the addition of a lithium imide salt of Formula (2), particularly LiN(SO₂CF₃)₂, reduces the impedance rise and capacity loss during long term cycling of lithium ion batteries containing water and a cyclic carbonate, particularly vinylene carbonate, suggesting that a lithium imide salt of Formula (2), particularly LiN(SO₂CF₃)₂, is a useful additive under conditions where moisture may not be controlled to tight tolerances.

In a typical lithium ion battery, a positive electrode includes an active material coated onto a positive current collector, and a negative electrode includes an active material coated onto a negative current collector.

The positive electrode includes a current collector made of a conductive material such as a metal. According to an exemplary embodiment, the current collector includes aluminum or an aluminum alloy. According to an exemplary embodiment, the thickness of the current collector is 5 μm to 75 μm. It should also be noted that while the positive current collector is often described as being a thin foil material, the positive current collector may have any of a variety of other configurations according to various exemplary embodiments. For example, the positive current collector may be a grid such as a mesh grid, an expanded metal grid, a photochemically etched grid, or the like.

The positive electrode includes a layer of active material coated on the current collector. The layer of active material can be provided on only one side of the current collector or it may be provided or coated on both sides of the current collector. Typically, the active material of the positive electrode includes a lithium metal oxide. In an exemplary embodiment, the primary active material is selected from lithium cobalt oxide (LiCoO₂ or “LCO”), LiCoₓNi₍₁₋ₓ₎O₂ wherein x is 0.05 to 0.8, LiAlₓCo_{y}Ni_{(1-x-y)}O₂ wherein x is 0.05 to 0.3 and y is 0.1 to 0.3, LiMn₂O₄, LiNiO₂, LiMnO₂, Li(Ni_{1/2}Mn_{1/2})O₂, Li(Mn_{1/3}Ni_{1/3}Co_{1/3})O₂, Li(Mn_{1/3}Ni_{1/3}Co_{1/3-x}Mgₓ)O₂, Li(Mn_{0.4}Ni_{0.4}Co_{0.2})O₂, LiNi_{0.42}Mn_{0.42}Co_{0.16}O₂ Li(Mn_{0.1}Ni_{0.1}Co_{0.8})O₂, Li(Ni_{0.8}Co_{0.15}Al_{0.05})O₂, LiMn_{1.5}Ni_{0.5}O₄, LiNiCuO₄, LiNi_{0.5}Ti_{0.5}O₄, Li₂MnO₃, LiV₃O₈, LiV₂O₅, LiV₆O₁₃, LiFePO₄, LiVOPO₄, Li₃V₂(PO₄)₃, and combinations thereof. The thickness of the active material of the positive electrode is typically 0.1 μm to 3 mm. According to other exemplary embodiments, the thickness of the active material is 10 μm to 300 μm. According to another exemplary embodiment, the thickness of the active material is 20 μm to 90 μm.

The negative electrode includes a current collector made of a conductive material such as a metal. According to an exemplary embodiment, the current collector includes copper or a copper alloy. According to another exemplary embodiment, the current collector is titanium or a titanium alloy. According to another exemplary embodiment, the current collector is nickel or a nickel alloy. According to another exemplary embodiment, the current collector is aluminum or an aluminum alloy. According to an exemplary embodiment, the thickness of the current collector is 5 μm to 75 μm. It should also be noted that while the negative current collector has been illustrated and described as being a thin foil material, the negative current collector may have any of a variety of other configurations according to various exemplary embodiments. For example, the negative current collector may be a grid such as a mesh grid, an expanded metal grid, a photochemically etched grid, or the like.

The negative electrode includes a layer of active material coated on the current collector. The layer of active material can be provided on only one side of the current collector or it may be provided or coated on both sides of the current collector. Typically, the active material of the negative electrode includes a carbonaceous material (e.g., carbon such as graphite), a silicon material, a lithium material, a titanate material, or a combination thereof. A preferred material is a lithium titanate material such as Li₄Ti₅O₁₂ (“LTO”), Li₄[Ti_{1.67}Li_{0.33-y}M_{y}]O₄, Li₂TiO₃, Li₄Ti_{4.75}V_{0.25}O₁₂, Li₄Ti_{4.75}Fe_{0.25}O_{11.88}, Li₄Ti_{4.5}Mn_{0.5}O₁₂, and combinations thereof. The thickness of the active material of the negative electrode is typically 0.1 μm to 3 mm. According to other exemplary embodiments, the thickness of the active material is 10 μm to 300 μm. According to another exemplary embodiment, the thickness of the active material is 20 μm to 90 μm.

In certain embodiments, the lithium ion battery charge carrying medium includes a solvent (typically, a non-aqueous solvent) and a lithium salt.

In certain embodiments, the solvent comprises an organic carbonate. In certain embodiments, the organic carbonate includes ethylene carbonate, dimethyl carbonate, diethyl carbonate, ethyl methyl carbonate, vinylene carbonate, 2-fluoroethylene carbonate, or a combination thereof.

In certain embodiments, the lithium salt is selected from LiPF₆, LiBF₄, LiClO₄, lithium bis(oxalato)borate, LiN(SO₂CF₃)₂, LiN(SO₂C₂F₅)₂, LiAsF₆, LiC(SO₂CF₃)₃, LiN(SO₂F)₂, LiN(SO₂F)(SO₂CF₃), LiN(SO₂F)(SO₂C₄F₉), and combinations thereof.

A lithium ion battery also typically includes a separator (e.g., a polymeric microporous separator, not shown) provided intermediate or between the positive electrode 20 and the negative electrode 30 (see FIG. 1). The electrodes 20 and 30 may be provided as relatively flat or planar plates or may be wrapped or wound in a spiral or other configuration (e.g., an oval configuration). For example, the electrodes may be wrapped around a relatively rectangular mandrel such that they form an oval wound coil for insertion into a relatively prismatic battery case. According to other exemplary embodiments, the battery may be provided as a button cell battery, a thin film solid state battery, or as another lithium ion battery configuration.

According to an exemplary embodiment, the separator can be a polymeric material such as a polypropylene/polyethelene copolymer or another polyolefin multilayer laminate that includes micropores formed therein to allow electrolyte and lithium ions to flow from one side of the separator to the other. The thickness of the separator is between approximately 10 micrometers (μm) and 50 μm according to an exemplary embodiment. According to a particular exemplary embodiment, the thickness of the separator is approximately 25 μm and the average pore size of the separator is between approximately 0.02 μm and 0.1 μm.

### Illustrative Embodiments

1. An electrolyte solution for a lithium ion battery, the electrolyte solution comprising:

a lithium ion battery charge carrying medium; and
water;
a cyclic carbonate; and
a lithium imide salt;
wherein the water is present in an amount of at least 100 ppm, based on the total weight of the electrolyte solution.

2. The electrolyte solution of embodiment 1 wherein water is present in an amount of at least 200 ppm.

3. The electrolyte solution of embodiment 1 or 2 wherein water is present in an amount of less than 2000 ppm.

4. The electrolyte solution of embodiment 3 wherein water is present in an amount of less than 1000 ppm.

5. The electrolyte solution of any of embodiments 1 through 4 wherein the cylic carbonate is present in an amount of at least 0.1 weight percent, based on the total weight of the electrolyte solution.

6. The electrolyte solution of any of embodiments 1 through 5 wherein the cyclic carbonate includes a carbon-carbon unsaturated bond.

7. The electrolyte solution of embodiment 6 wherein the cyclic carbonate is selected from vinylene carbonate, vinyl ethylene carbonate, and combinations thereof.

8. The electrolyte solution of any of embodiments 1 through 5 wherein the cyclic carbonate has the following Formula (1):

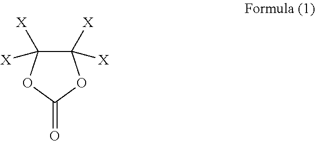

wherein each X is independently a hydrogen or a halogen, and at least one X is a halogen.

9. The electrolyte solution of embodiment 8 wherein the cyclic carbonate comprises fluoro ethylene carbonate.

10. The electrolyte solution of any of embodiments 1 through 9 wherein the lithium imide salt is present in an amount of least 0.1 weight percent, based on the total weight of the electrolyte solution.

11. The electrolyte solution of any of embodiments 1 through 10 wherein the lithium imide salt has the following Formula (2):

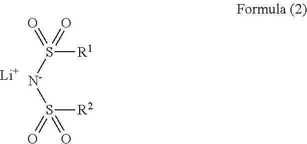

wherein:
   R¹ represents CₘX₂ₘ₊₁;
   R² represents CₙX₂ₙ₊₁;
   m and n are each independently an integer of 1 to 8; and
   each X is independently a hydrogen or halogen.

12. The electrolyte solution of embodiment 11 wherein the lithium imide salt comprises LiN(SO₂CF₃)₂.

13. The electrolyte solution of any of embodiments 1 through 12 wherein the lithium ion battery charge carrying medium comprises a solvent and a lithium salt.

14. The electrolyte solution of embodiment 13 wherein the solvent comprises an organic carbonate.

15. The electrolyte solution of embodiment 14 wherein the organic carbonate comprises ethylene carbonate, dimethyl carbonate, diethyl carbonate, ethyl methyl carbonate, vinylene carbonate, 2-fluoroethylene carbonate, or a combination thereof.

16. The electrolyte solution of any one of embodiments 13 through 15 wherein the lithium salt is selected from LiPF₆, LiBF₄, LiClO₄, lithium bis(oxalato)borate, LiN(SO₂CF₃)₂, LiN(SO₂C₂F₅)₂, LiAsF₆, LiC(SO₂CF₃)₃, LiN(SO₂F)₂, LiN(SO₂F)(SO₂CF₃), LiN(SO₂F)(SO₂C₄F₉), and combinations thereof.

17. An electrolyte solution for a lithium ion battery, the electrolyte solution comprising:

a lithium ion battery charge carrying medium; and
water;
a cyclic carbonate that includes a carbon-carbon unsaturated bond or a cyclic carbonate of Formula (1):

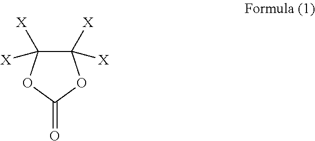

wherein each X is independently a hydrogen or a halogen, and at least one X is a halogen; and
a lithium imide salt has the following Formula (2):

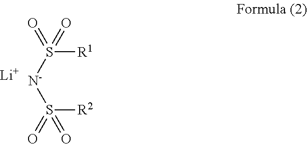

wherein:
   R¹ represents CₘX₂ₘ₊₁;
   R² represents CₙX₂ₙ₊₁;
   m and n are each independently an integer of 1 to 8; and
   each X is independently a hydrogen or halogen;
   wherein the water is present in an amount of at least 100 ppm, based on the total weight of the electrolyte solution.

18. The electrolyte solution of embodiment 17 wherein the cyclic carbonate includes a carbon-carbon unsaturated bond.

19. The electrolyte solution of embodiment 18 wherein the cyclic carbonate is selected from vinylene carbonate, vinyl ethylene carbonate, and combinations thereof.

20. A lithium ion electrochemical cell comprising:
a positive electrode;
a negative electrode; and
an electrolyte solution according to any one of embodiments 1 through 19.

21. The lithium ion electrochemical cell of embodiment 20 wherein the positive electrode comprises a lithium metal oxide.

22. The lithium ion electrochemical cell of embodiment 20 or 21 wherein the negative electrode comprises carbon, silicon, lithium, titanate, or a combination thereof.

### EXAMPLES

Objects and advantages of this disclosure are further illustrated by the following examples, but the particular materials and amounts thereof recited in these examples, as well as other conditions and details, should not be construed to unduly limit this disclosure.

### List of Materials

| Name | Description | Source |
|---|---|---|
| EC | Ethylene Carbonate | BASF, USA |
| EMC | Ethyl Methyl Carbonate | BASF, USA |
| LiPF₆ | Lithium hexafluoro | BASF, USA |
| | phosphate | |
| NMC | LiNi_{0.42}Mn_{0.42}Co_{0.16}O₂ | 3M, USA |
| LCO | LiCoO₂ | Umicore, Korea |
| Conductive | Super P | Timcal graphite |
| Carbon | | and carbon, |
| | | Switzerland |
| PVDF | Polyvinylidene Fluoride | Arkema, USA |
| MCMB | Methyl Carbon Micro Bead | Hitachi, Japan |
| NMP | N-Methyl-2-Pyrrolidone | Honeywell, USA |
| LTO | Li₄Ti₅O₁₂ | ISK, Japan |
| VC | Vinylene Carbonate | BASF, USA |
| HQ-115 | Lithium | 3M, USA |
| | bis(trifluoromethane) | |
| | sulfonimide | |

### Electrochemical Cell Preparation.

### Preparation of Electrolyte

A non-aqueous electrolyte comprising of 1M LiPF₆ lithium salt, ethylene carbonate (EC):ethyl methyl carbonate (EMC) having a ratio of 3:7 by weight was obtained from Novolyte, Independence, Ohio. Various amounts of additives were added to the 1.0M electrolyte solution, as indicated in the Examples below. The additives were introduced in a <2% relative humidity (RH) dry room.

### Preparation of NMC/Graphite Wound Prismatic Cells

The wound prismatic cell in this disclosure included a negative electrode, a positive electrode, a separator and electrolyte inside the battery encasement. The negative electrode was connected to the battery encasement as the negative polarity via a negative tab. The positive electrode was connected to the positive feedthrough pin via a positive tab. The positive electrode included a positive active material NMC (90.5% by wt) coated on aluminum foil (20 μm thick) as the current collector, with conductive carbon (6.4% by weight) and PVDF (3.1% by weight). The negative electrode included a negative active material (MCMB) coated on copper foil (10 ₗam thick) as the current collector, with conductive carbon (2.1% by weight) and PVDF (10.0% by weight). The positive coating thicknesses ranged from 25-75 μm per side of the foil. The negative electrode thickness ranged from 25-75 μm per side of the foil. The separator used was tri-layer shutdown separator from Celgard (2320) with 20 μm nominal thickness. The electrodes were slurry coated using NMP (N-Methyl-2-pyrrolidone) as the solvent on both sides of the current collector foils. The electrodes were calendared to the target thickness using compression rollers. The coated and compressed electrodes were cut to the target width and length. The electrode tabs were welded to the respective electrode after compression. The tabbed electrodes were coiled along with the separator. The negative electrode tabs were welded to the tab attached to the battery cover. The positive tab was welded to the feedthrough pin attached to the battery cover. The coil assembly, attached to the battery cover was inserted into the battery case and was welded shut. Electrolyte, with the appropriate additive composition, was filled into the battery case through the electrolyte fill port. The fill port was welded shut with a fill port button. The filled battery was charged to the full charge voltage at C/10 rate (a 10 hour charge rate) and held at open circuit voltage for one day. Subsequent cycling and diagnostics were conducted on the cells after the initial formation. The negative to positive capacity ratio of the cell is designed such that at the top of the charge, the negative potential versus Li⁺/Li doesn't vary a lot with change in lithiation level. The MCMB electrode is believed to be at approximately 0.15V vs Li+/Li at the top of charge. This allowed the storage measurements at the top of charge to indicate effect of parasitic reactions at the positive.

### Preparation of LCO/Graphite Wound Prismatic Cells

The same processes as outlined above were followed, except a LiCoO₂ cathode active material was used in place of the NMC cathode active material.

### LCO or NMC/Graphite Wound Prismatic Cells Testing

Wound prismatic lithium ion cells were made to cycle duplicate cells on the high precision charger (HPC) and have duplicate cells available for tests using the high precision cycling/storage system, but in some cases only single cells were available.

The HPC was a custom built battery cycler described in J. Electrochem. Soc. 157, A196-A202 (2010). The HPC uses Keithley 220 (or 224 or 6220—all with equivalent specifications) precision current sources for current supplies and Keithley 2000 multimeters to measure cell voltage.

The high precision cycling/storage system was a custom built system as described in J. Electrochem. Soc. 158, A1194-A1201 (2011). This system was built to cycle cells similarly to the HPC and uses Keithley 220 current sources and Keithley 2000 (or 2700 with equivalent specifications) multimeters. However, once a cell has been cycled and fully charged it could be left for open circuit storage by opening a mechanical relay (true open circuit) which is only closed once every six hours for one second to make a voltage measurement. The current sources were multiplexed using Keithley 705 scanners so that while cells are in storage the current sources can be used to cycle other cells. This allowed four current sources to run forty cells through the cycling/storage procedure.

Cycling was conducted between 3.4 and 4.075 V for the LCO cells and between 3.3 and 4.225 V for the NMC cells. All cells were cycled with constant current charge and discharge steps at a rate of roughly C/20 at 40.0±0.5° C. for approximately 600 hours. After the approximately 600 hours of cycling, cells were set to 3.700 V and held at that voltage until the measured current flow decreased below the corresponding C/100 current. Impedance spectra were collected at 10.0±0.5° C. using a Biologic VMP3 (available from BioLogic Science Instruments, Claix France). Spectra were collected from 10 kHz-10 mHz with a signal amplitude of 10 mV. After collecting impedance data, cells were put at both 40° C. and 55° C. for long term cycling between the same voltage limits but using a corresponding C/10 charge and discharge current. All cells were typically cycled for 250 times at the rate C/10. In total, it took about 5000 hours (approximately 208 days) to achieve end of cycle life for all cells. Storage experiments consisted of cycling the cells twice before fully charging them to the above mentioned upper voltages all using constant current steps at a rate of roughly C/20. Cells were then left open circuit with mechanical relays for approximately 560 hours. All data is an average of two cells where pair cell data is available.

The first cycle irreversible capacity loss, cell swelling, coulombic efficiency, voltage drop, charge transfer resistance, and capacity retention during above electrochemical test and evaluation were determined as follows. First cycle irreversible capacity loss was defined as the difference in capacity between the first charge and first discharge divided by the first discharge capacity to normalize. Swelling was quantified as the change in cell width as measured by a linear gauge from before and after the formation process. The coulombic efficiency was the ratio of the discharge to charge capacity of a given cycle. The values given here were an average of the final three cycles over a approximately 600 hour cycling period on the High Precision Charger.

Coulombic efficiency has been shown to give accurate short term predictive ability for long term performance. The voltage drop during storage was defined as the change in cell voltage during a 500 hour open circuit storage period. Before storage, the cells were charged to 100% state of charge and then left open circuit by a mechanical relay which was only closed for one second every six hours to measure the cell voltage. Charge transfer resistance was measured from the width of the sum of the two semicircular features seen in a Nyquist plot (negative imaginary impedance versus real impedance). This measured the resistance in moving a Li⁺ ion from solution through any surface films and intercalated into the host material. Capacity retention is defined as the ratio of discharge capacity at cycle n to the initial discharge capacity of the long term cycling period. The long term cycling to measure the capacity retention was conducted on cells after cycling on the High Precision Charger and measuring impedance spectra.

### Evaluation of LCO/Graphite Prismatic Wound Cells

### Comparative Examples (CE) 1-7 and Examples (Ex) 1-2

Wound cells were prepared with LiCoO₂ cathodes and graphite anodes, as described above. The additives shown in Table 1 were added to the formulated electrolyte stock solution containing 1.0M LiPF₆ in 3:7 EC:EMC, described above.

TABLE 1
Additives to 1M Electrolyte Stock Solution for LCO/Graphite
Cells Comparative Examples 1-7 and Examples 1-2

| Sample | Additive and Amount |
|---|---|
| CE 1 | None |
| CE 2 | 100 ppm water |
| CE 3 | 1000 ppm water |
| CE 4 | 2% VC |
| CE 5 | 2% VC + 100 ppm water |
| CE 6 | 2% VC + 1000 ppm water |
| CE 7 | 2% VC + 2% HQ-115 |
| Ex 1 | 2% VC + 100 ppm water + 2% HQ-115 |
| Ex 2 | 2% VC + 1000 ppm water + 2% HQ-115 |

The cells for Comparative Examples 1-7 and Examples 1-2 were tested according to the protocol details above. Table 2 shows the results from these tests.

TABLE 2
LCO/Graphite Cell Testing Results
Comparative Examples 1-7 and Examples 1-2

| | | | | Voltage | | | |
|---|---|---|---|---|---|---|---|
| | First Cycle | | | Drop | Charge | Capacity | Capacity |
| | Irreversible | Swelling | | During | Transfer | Retention | Retention |
| | Capacity | during | Coulombic | Storage | Resistance | 40° C. | 55° C. |
| Sample | Low (%) | formation | Efficiency | (V) | (Ω-cm²) | Cycling (%) | Cycling (%) |
| CE 1 | 8.98 | 2.33 | 0.99562 | 0.0882 | 112 | 95.0 | 85.9 |
| CE 2 | 9.01 | 2.09 | 0.99562 | 0.0911 | 120 | 94.9 | 85.1 |
| CE 3 | 11.13 | 2.14 | 0.99564 | N/A | N/A | 96.8 | 86.9 |
| CE 4 | 10.58 | 2.05 | 0.99879 | 0.0405 | 82 | 95.6 | 93.7 |
| CE 5 | 11.57 | 26.84 | 0.99876 | 0.0434 | 54 | 92.2 | 85.7 |
| CE 6 | 9.96 | 17.95 | 0.99896 | 0.0349 | 56 | 95.6 | 88.9 |
| CE 7 | 10.82 | 3.53 | 0.99874 | 0.0386 | 66 | N/A | 90.2 |
| Ex 1 | 10.87 | 2.35 | 0.99869 | 0.0397 | 83 | 96.4 | 90.3 |
| Ex 2 | 9.36 | 9.45 | 0.99903 | 0.0325 | 53 | 96.0 | 92.6 |

Table 2 shows that the addition of 100 ppm (Ex 1) or 1000 ppm (Ex 2) water to electrolyte containing VC and HQ-115 in LCO/graphite cells gives the best overall cell performance with high measured coulombic efficiencies, low voltage drop during storage, good capacity retention during long term cycling, low charge transfer resistance and only moderate swelling.

### Evaluation of NMC/Graphite Wound Prismatic Cells

### Comparative Examples (CE) 8-14 and Examples (Ex) 3-4

Wound cells were prepared with LiNi_{0.42}Mn_{0.42}Co_{0.16}O₂ cathodes and graphite anodes, as described above. The additives shown in Table 3 were added to the formulated electrolyte stock solution containing 1.0M LiPF₆ in 3:7 EC:EMC, described above.

TABLE 3
Additives to 1M Electrolyte Stock Solution for NMC/Graphite
Cells Comparative Examples 8-14 and Examples 3-4

| Sample | Additive and Amount |
|---|---|
| CE 8 | None |
| CE 9 | 100 ppm water |
| CE 10 | 1000 ppm water |
| CE 11 | 2% VC |
| CE 12 | 2% VC + 100 ppm water |
| CE 13 | 2% VC + 1000 ppm water |
| CE 14 | 2% VC + 2% HQ-115 |
| Ex 3 | 2% VC + 100 ppm water + 2% HQ-115 |
| Ex 4 | 2% VC + 1000 ppm water + 2% HQ-115 |

The cells for Comparative Examples 8-14 and Examples 3-4 were tested according to the protocol details above. Table 4 shows the results from these tests.

TABLE 4
NMC/Graphite Cell Testing Results
Comparative Examples 8-14 and Examples 3-4

| | | | | Voltage | | | |
|---|---|---|---|---|---|---|---|
| | First Cycle | | | Drop | Charge | Capacity | Capacity |
| | Irreversible | Swelling | | During | Transfer | Retention | Retention |
| | Capacity | during | Coulombic | Storage | Resistance | 40° C. | 55° C. |
| Sample | Low (%) | formation | Efficiency | (V) | (Ω-cm²) | Cycling (%) | Cycling (%) |
| CE 8 | 9.51 | 0.89 | 0.99744 | 0.0887 | 58 | 78.8 | N/A |
| CE 9 | 9.45 | 0.82 | 0.99740 | 0.0914 | 57 | 78.5 | 61.3 |
| CE 10 | 12.11 | 2.00 | 0.99735 | N/A | N/A | 82.0 | 74.5 |
| CE 11 | 11.77 | 0.86 | 0.99821 | 0.0742 | 79 | 86.9 | 74.0 |
| CE 12 | 12.18 | 24.45 | 0.99875 | 0.0797 | 69 | 88.5 | 71.9 |
| CE 13 | 10.84 | 15.01 | 0.99882 | 0.0633 | 66 | 88.0 | 73.0 |
| CE 14 | 8.35 | 2.13 | 0.99840 | 0.0672 | 67 | N/A | 74.9 |
| Ex 3 | 10.92 | 0.46 | 0.99824 | 0.0731 | 80 | 87.0 | 70.2 |
| Ex 4 | 10.10 | 6.95 | 0.99875 | 0.0578 | 64 | 87.8 | 76.8 |

Table 4 shows that the addition of 100 ppm (Ex 3) or 1000 ppm (Ex 4) water to electrolyte containing VC and HQ-115 in NMC/graphite cells gives the best overall cell performance with high measured coulombic efficiencies, low voltage drop during storage, good capacity retention during long term cycling, low charge transfer resistance and only moderate swelling. The cell containing 1000 ppm water (Ex 4) has better performance but higher swelling relative to the cell containing 100 ppm water (Ex 3).

The complete disclosures of the patents, patent documents, and publications cited herein are incorporated by reference in their entirety as if each were individually incorporated. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

1. An electrolyte solution for a lithium ion battery, the electrolyte solution comprising:
a lithium ion battery charge carrying medium; and
water;
a cyclic carbonate; and
a lithium imide salt, wherein the lithium imide salt comprises LiN(SO₂CF₃)₂;
wherein the water is present in an amount of at least 100 ppm, based on the total weight of the electrolyte solution.

2. The electrolyte solution of claim 1 wherein water is present in an amount of at least 200 ppm.

3. The electrolyte solution of claim 1 wherein water is present in an amount of less than 2000 ppm.

4. The electrolyte solution of claim 3 wherein water is present in an amount of less than 1000 ppm.

5. The electrolyte solution of claim 1 wherein the cyclic carbonate is present in an amount of at least 0.1 weight percent, based on the total weight of the electrolyte solution.

6. The electrolyte solution of claim 1 wherein the cyclic carbonate includes a carbon-carbon unsaturated bond.

7. The electrolyte solution of claim 6 wherein the cyclic carbonate is selected from vinylene carbonate, vinyl ethylene carbonate, and combinations thereof.

8. The electrolyte solution of claim 1 wherein the cyclic carbonate has the following Formula (1): 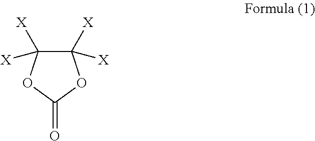
wherein each X is independently a hydrogen or a halogen, and at least one X is a halogen.

9. The electrolyte solution of claim 8 wherein the cyclic carbonate comprises fluoro ethylene carbonate.

10. The electrolyte solution of claim 1 wherein the lithium imide salt is present in an amount of at least 0.1 weight percent, based on the total weight of the electrolyte solution.

11-12. (canceled)

13. The electrolyte solution of claim 1 wherein the lithium ion battery charge carrying medium comprises a solvent and a lithium salt.

14. The electrolyte solution of claim 13 wherein the solvent comprises an organic carbonate.

15. The electrolyte solution of claim 14 wherein the organic carbonate comprises ethylene carbonate, dimethyl carbonate, diethyl carbonate, ethyl methyl carbonate, vinylene carbonate, 2-fluoroethylene carbonate, or a combination thereof.

16. The electrolyte solution of claim 13 wherein the lithium salt is selected from LiPF₆, LiBF₄, LiClO₄, lithium bis(oxalato)borate, LiN(SO₂CF₃)₂, LiN(SO₂C₂F₅)₂, LiAsF₆, LiC(SO₂CF₃)₃, LiN(SO₂F)₂, LiN(SO₂F)(SO2CF3), LiN(SO₂F)(SO₂C₄F₉), and combinations thereof.

17. (canceled)

18. A lithium ion electrochemical cell comprising:
a positive electrode;
a negative electrode; and
an electrolyte solution according to claim 1.

19. (canceled)

20. The lithium ion electrochemical cell of claim 18 wherein the positive electrode comprises a lithium metal oxide and the negative electrode comprises carbon, silicon, lithium, titanate, or a combination thereof.
